(19) United States
(12) Patent Application Publication
(10) Pub. No.: US 2023/0114193 A1
(43) Pub. Date: Apr. 13, 2023

(54) Attachable Pad Device

(71) Applicant: David Wayne Waddell, Calgary (CA)

(72) Inventor: David Wayne Waddell, Calgary (CA)

(21) Appl. No.: 18/075,349

(22) Filed: Dec. 5, 2022

Related U.S. Application Data
(63) Continuation-in-part of application No. 16/582,009, filed on Sep. 25, 2019.

(51) Int. Cl. E06C 7/00

(52) U.S. Cl. CPC E06C 7/00

(57) ABSTRACT

Disclosed is an attachable pad to attach to a ladder, including: a main frame including: a middle portion, and a first end portion attached to a first end of the middle portion. The first end portion is folded to a first folding degree outward of the first side of the middle portion. The main frame includes a second end attached to a second end of the middle portion, in which the second end portion is folded to the first folding degree outward of the first side of the middle portion. The attachable pad device includes a first bracket attached to an upper left portion of a second side of the middle portion, a second bracket attached to an upper right portion of the second side of the middle portion, and a mechanism to attach the first bracket and the second bracket to the second side of the middle portion.

### REFERENCE TO PENDING APPLICATIONS

This application claims benefit of pending U.S. Pat. Applications, Serial No. 16,582,009 filed Sep. 25, 2019.

### BACKGROUND OF THE INVENTION

### Field of the Invention

The present invention relates generally to a pad, and in particular to an attachable pad to attach to a ladder.

### Background

Ladders, when used effectively, make large-scale jobs easier. Anyone using ladders regularly, such as construction workers, understands the advantages of this tool. The workers gain access to hard to reach spots with light and portable equipment. Although set up a ladder and take down from it is quick and easy, when used carelessly, the aforementioned benefits are overshadowed by the potential hazards. Even with proper training the ladders may impose safety hazards on the worker. For instance, when a user needs to use both of his hands at once to do a certain job, his safety is at risk. Even if the user braced against the ladder for stability, his knees could get hurt. There are several types of devices and methods in use to tackle safety problems, however, there is ample room for improvement, specifically in providing a device to attach to a ladder to improve user’s safety and to enhance his comfort and confidence at the same time.

DE202004000024U1 discloses a flat, rigid panel with a width slightly less than a main vertical side-members. The panel has a hook at the top end which clips onto a ladder rung. The panel further has an upholstered outer surface. The device is used for preventing painful pressure points on the shins and knees for use of ladders or in the use of scaffolding or on hard materials. The device is a cushioned surface, which can be used from the width forth in any standard conductor. For this purpose, located in the upper part of a U-shaped manner curved/canted results to be hooked into the respective rung.

US20040069569A1 discloses a comfort attachment for a ladder for a worker to stand on. The attachment structure has a large step as may be found on a stairway and vertical cushioned area against which a worker my lean that will provide support for their legs. The attachment is secured to a ladder by means of spring-loaded brackets on the top and a bracket on the bottom that fits securely over a ladder rung. When installed the attachment provides a horizontal step to stand on and a vertical cushion to lean against.

US20180209215A1 discloses a ladder knee rest comprising a padded frame with top and bottom lateral arms separated by a central support column. The frame can be hung in front of a ladder with a positioning strap, and the length of the positioning strap can be adjusted to move the frame vertically up or down the ladder. Securing straps extending from the lateral arms can be connected behind the ladder and tightened to prevent side-to-side movement. A user’s knees can be placed between the padded top and bottom lateral arms to reduce pain and/or discomfort in the user’s legs while the user works on the ladder.

US20120228058A1 discloses a step guard device that enables a user to prevent a small or unsupervised child from ascending a ladder such as the type commonly used with swing sets, tree house, and the like by preventing the small child from accessing one or more rungs or steps of the ladder. The step guard device is preferably comprised of a barricade and an attachment device for removably attaching said device to the ladder. The device can also be positioned along the ladder so as to permit bigger children and/or adults to safely traverse the device and use the ladder to enjoy the structure to which it is attached.

US20110042166A1 discloses a portable safety device locks onto a step of a ladder to provide cushioning for the legs and to prevent the user from tipping the ladder sideways. The device comprises a center component connected to two U-shaped leg braces, a closeable handle, and a retractable clamp. The retractable clamp is extended when the closeable handle is opened and retracted when the closeable handle is closed. In the retracted position, the clamp securely grasps the front and rear edges of a selected step on the ladder to effectively attach the device to the ladder in an operable position. The two leg braces partially surround the user’s lower legs, between the ankle and the knee, and include a cushion material for added comfort when the user’s legs lean against the braces. The leg braces attach to the center component by locking into a horizontal track which allows the braces to be separated or brought together to adjust for the user’s natural stance and leg separation. The leg braces help to stabilize the user when standing on the ladder and discourage the user from leaning dangerously too far to either side of the ladder, thereby preventing the ladder from tipping and possibly injuring the user.

US6994185B1 discloses a ladder rung pad assembly for providing a selectively position-able pad for attaching to a rung of a ladder adjacent to a shin or other part of the body that typically rests against the ladder rung while the user stands on the ladder. The ladder ring pad assembly includes a plastic clip member having a pair of resilient arms for gripping a ladder rung. An exterior surface of the clip member is covered by a pad member. The pad member is optionally covered by a cover member. Each of the resilient arms has a distal hook portion to facilitate coupling the clip member to the ladder rung.

US20070074932A1 discloses a padding device that is adapted to attach to the individual steps or rungs of a ladder to cushion the step or rung to which it is attached, thereby providing comfort and protection to the legs and shins of an individual who is using the ladder. The padding device is adapted to attach to the steps or rungs of a ladder to cushion the step or rung thereby providing comfort and protection to the legs and shins of an individual who is using the ladder.

US6415890B1 discloses a padded ladder protector is an easily attachable and detachable device for mounting on edges of a ladder to cushion and protect the user from injury. The protector is made of a foamed polymer with an adhesive surface covered by a peel strip. By removing the peel strip, the protector may be temporarily attached to edges of the rungs or tray or other parts of the ladder as desired by the user. After a specific use, the protector can be easily removed, and another protector may be placed on the same parts or other parts of the ladder. The protector may also be adhesively attached to a rigid support which can be attached to the ladder.

US6729438B1 discloses a ladder padding device for cushioning the rungs of ladders for the users thereof. The ladder padding device includes a piece of material being adapted to be fastened about a rung of a ladder; and also includes fastening members being attached to the piece of material for fastening the piece of material to the rung of the ladder; and further includes a padding being disposed in the piece of material for cushioning the rung of the ladder.

US20090211843A1 discloses a ladder pad assembly for use with a ladder having at least one rail and at least one pair of rungs. In some implementations, the ladder pad assembly includes a body having a volume of padding material provided therein, and a fastening arrangement that is attached to body. The body is configured to wrap around the rail to be at least partially disposed between rungs of the at least one pair of rungs, and the fastening arrangement is arranged to releasably secure the body to the rail.

US20110005863A1 discloses a protective article and a ladder having a protective article with a body and an adjustable securing feature to attach the protective article to the ladder to cushion against impact by a user. The protective article for use with a ladder to provide cushioning support, comfort, and protection to ladder users. The protective article includes a body to prevent contact with the ladder and an adjustable securing feature for securing the body to the ladder. The adjustable securing feature can be attached to an exterior surface of the body. Alternatively, the protective article can be provided with a covering and the adjustable securing feature can be attached to an exterior surface of the covering.

GB2400886A discloses a ladder rung accessory comprising a flexible hollow tubular pad to be fitted over a ladder rung. The pad has a longitudinal slit which allows it to be fitted to the rung, and which is sealed with a sealing element. The rung pad offers comfort to the user by alleviating point contact pressure on the knees.

### BRIEF SUMMARY

In some embodiments, an attachable pad device to attach to a ladder is disclosed. In some embodiments, the attachable pad device includes a main frame, a first bracket, otherwise referred to as a first aperture, a second bracket, otherwise referred to as a second aperture, and a first plurality of attachment mechanisms. The main frame includes a middle portion, a first end portion, and a second end portion. The middle portion is substantially a flat surface. The first end portion is attached to a first end of the middle portion. In some embodiments, the first end portion is folded to a first folding degree towards a first side of the middle portion. The second end portion is attached to a second end of the middle portion. The second end portion is folded to the first folding degree towards the first side of the middle portion.

In some embodiments, the first aperture is the same as the second aperture. In some embodiments, the first and second apertures are parallelly attached to an upper left and an upper right portion of a second side of the middle portion, respectively.

In some embodiments, the first plurality of mechanisms attaches the first aperture and the second aperture to the first side and second side of the middle portion, respectively. In some embodiments, the main frame includes a hole. The hole may be located in the middle portion and be used as a handle for handling the attachable pad.

In some embodiments, the attachable pad includes a first cushion and a second cushion. The first and second cushions are used to add comfort to the user of the ladder. In some embodiments, a main portion of the first cushion, or the second cushion, covers the first side, or second side, of the middle portion. The main portion covers at least partially the first side, or the second side, of the middle portion. In some embodiments, a first end portion of the first cushion, or the second cushion, covers the first side, or the second side, of the first end portion. The first end portion covers at least partially the first side, or the second side, of the first end portion. In some embodiments, a second end portion of the first cushion, or the second cushion, covers the first side, the second side, of the second end portion. The second end portion covers at least partially the first side, or the second side, of the second end portion. In some embodiments, the first cushion and the second cushion are made of water resistance materials.

### BRIEF DESCRIPTION OF THE DRAWINGS

that the present disclosure can be understood by those of ordinary skill in the art, a more detailed description can be had by reference to aspects of some illustrative embodiments, some of which are shown in the accompanying drawings.

FIG. 1A illustrates a front-view of an attachable pad to attach a ladder, in accordance with some embodiments.

FIG. 1B illustrates a back-view of an attachable pad to attach a ladder, in accordance with some embodiments.

FIG. 1C illustrates a side-view of an attachable pad to attach a ladder, in accordance with some embodiments.

FIG. 2 illustrates an attachable pad to attach a ladder, in accordance with some embodiments.

FIG. 3 illustrates an exemplary aperture for an attachable pad to attach a ladder, in accordance with some embodiments.

FIG. 4 is a front view of an embodiment of the present invention attached to a ladder.

FIG. 5 is a back view of an embodiment of the present invention attached to a ladder.

FIG. 6 is a side view of an embodiment of the present invention attached to a ladder along line AA in FIG. 4.

FIG. 7 is a front-view of an embodiment of the present invention.

FIG. 8 is a back-view of an embodiment of the present invention.

FIG. 9 is a side-view of an embodiment of the present invention.

FIG. 10 is a top-view of an embodiment of the present invention.

FIG. 11 is a side-view of an embodiment of a bracket for attaching to the attachable pad of the present invention.

FIG. 12 is a close up side view of an embodiment of a bracket for attaching to the attaching pad of the present invention.

FIG. 13 is a close up side view of an additional embodiment of a bracket for attaching to the attaching pad of the present invention.

FIG. 14 is a side view of an additional embodiment of the present invention.

### DETAILED DESCRIPTION

In accordance with common practice some features illustrated in the drawings cannot be drawn to scale. Accordingly, the dimensions of some features can be arbitrarily expanded or reduced for clarity. In addition, some of the drawings cannot depict all of the components of a given system, method or device. Finally, like reference numerals can be used to denote like features throughout the specification and figures.

It will also be understood that, although the terms first, second, etc. are, in some instances, used herein to describe various elements, these elements should not be limited by these terms. These terms are only used to distinguish one element from another. For example, a first device could be termed a second device, and, similarly, a second device could be termed a first device, without departing from the scope of the various described embodiments. The first device and the second device are both devicees, but they are not the same device, unless the context clearly indicates otherwise.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be appreciated that in the development of any actual embodiment (as in any development project), numerous decisions must be made to achieve the developers’ specific goals (e.g., compliance with system and business-related constraints), and that these goals will vary from one embodiment to another. It will also be appreciated that such development efforts might be complex and time consuming but would nevertheless be a routine undertaking for those of ordinary skill in the art of image capture having the benefit of this disclosure.

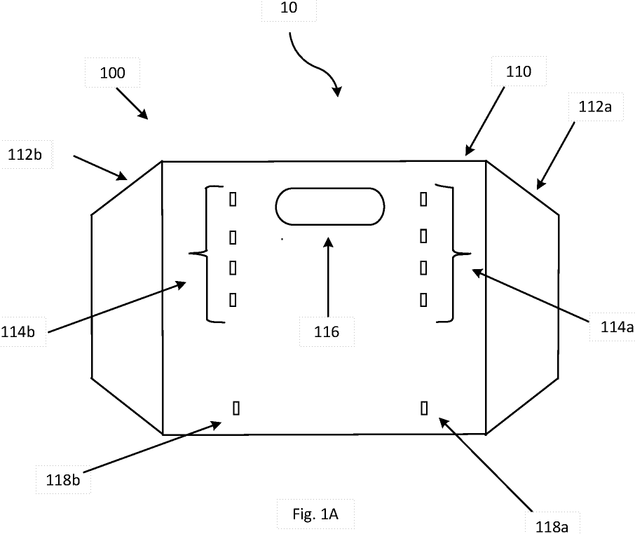

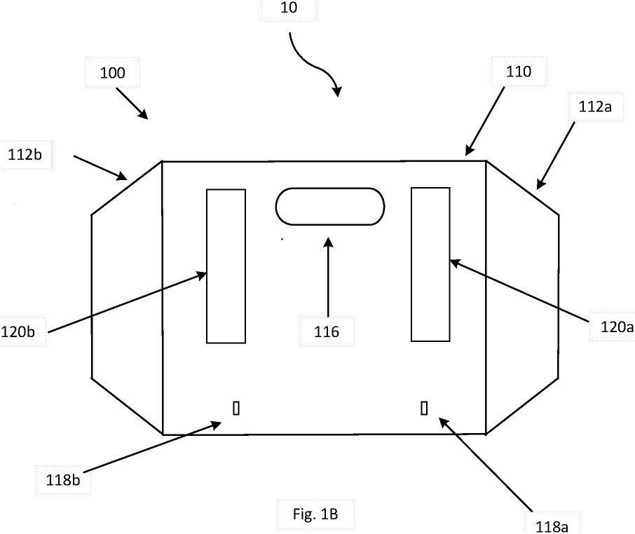

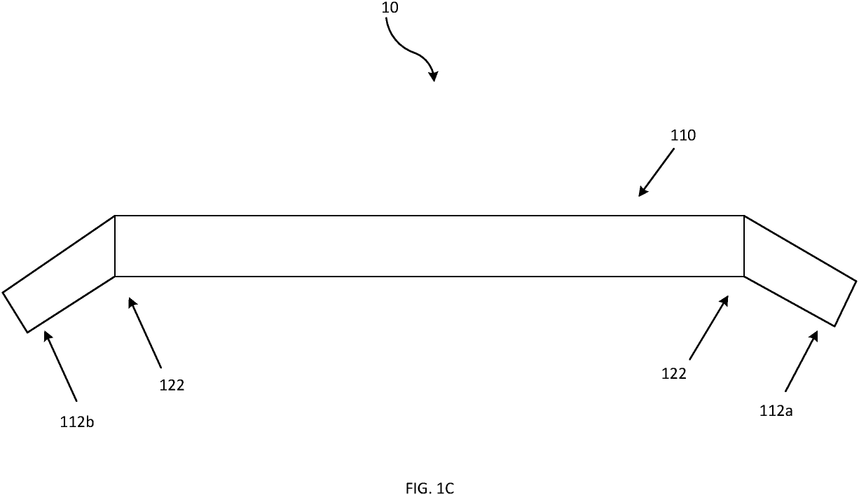

FIGS. 1A-1C illustrate different views of an attachable pad to attach a ladder, in accordance with some embodiments. In some embodiments, the attachable pad device 10 includes a main frame 100, a first aperture 120a, a second aperture 120b, and a first plurality of attachment mechanisms 114a and 114b. The main frame 100 includes a middle portion 110, first end portion 112a, and a second end portion 112b. The middle portion 110 is substantially a flat surface. The first end portion 112a is attached to a first end of the middle portion 110. The first end portion 112a is folded to a first folding degree 122 towards a first side of the middle portion 110 and in a direction perpendicular to the first side. The second end portion 112b is attached to a second end of the middle portion 110. The second end portion 112b is folded to the first folding degree 122 towards the first side of the middle portion 110 and in a direction perpendicular to the first side. In some embodiments, the first folding degree is about 30 degrees to about 45 degrees, as shown in FIG. 1C. In some embodiments, the middle portion 110 has a length of about 9 inches to about 19 inches, and a width of about 14 inches to about 24 inches. The first end portion 112a and the second end portion 112b have a length of about 9 inches to about 19 inches, and a width of about 1 inch to about 7 inches. In a preferred embodiment, the middle portion 110 has a length of about 14 inches and a width of about 19 inches. The first end portion 112a and the second end portion 112b have a length of about 14 inches, and a width of about 4 inches.

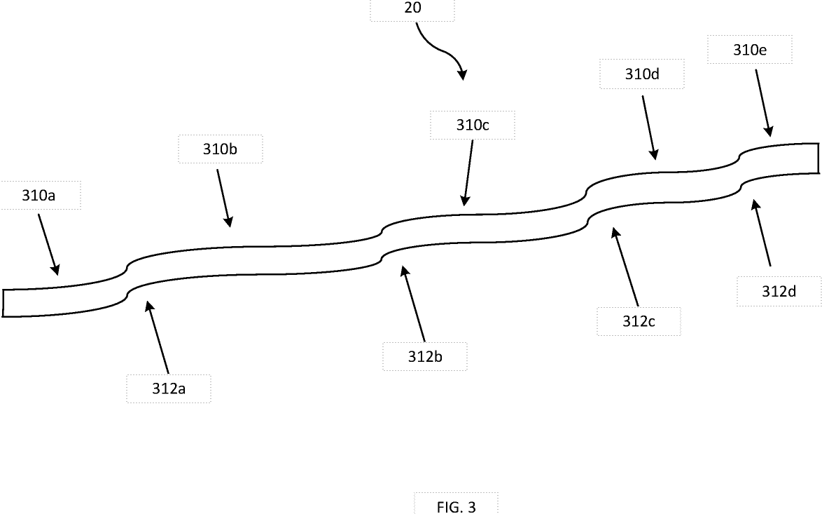

In some embodiments, the first aperture 120a is same as the second aperture 120b. For sake of simplicity, both the first aperture 120a and the second aperture 120b are shown by a single aperture 20 shown in FIG. 3. In some embodiments, the first aperture 120a is attached to an upper left portion of a second side of the middle portion 110. The second aperture 120b is attached to an upper right portion of the second side of the middle portion 110.

In some embodiments, one or more attachment mechanism 114a of the first plurality of mechanisms attaches the first aperture 120a to the first side of the middle portion 110. In some embodiments, one or more attachment mechanism 114b of the first plurality of attachment mechanisms attaches the second aperture 120b to the second side of the middle portion 110. In some embodiments, the main frame 100 includes a hole 116. The hole 116 may be located in the middle portion 110. The hole 116 is used for handling the attachable pad 10. In some embodiments, the hole 116 is used as a handle to move the attachable pad 10. In some embodiments, the hole has a length of about 1 inch to about 7 inches, and a width of about 1 inch to about 4 inches. In a preferred embodiment, the hole has a length of about 4 inches to about 5 inches, and a width of about 2 inches to about 2.5 inches.

FIG. 1B illustrates a back-view of an attachable pad 10 to attach a ladder, in accordance with some embodiments. In some embodiments, the attachable pad 10 includes the first aperture 120a and the second aperture 120b. The first aperture 120a and the second aperture 120b are used to attach the attachable pad 10 to a ladder. The first aperture 120a and the second aperture 120b are so designed that they grip to the ladder firmly, thus enable a user of the ladder to lean towards the attachable pad 10 securely.

In some embodiments, the middle portion 110 of the main frame 100 includes one or more second plurality of attachment mechanisms 118a and 118b. The one or more second plurality of attachment mechanism 118a and 118b is used to attach the attachable pad 10 to the ladder (not shown), in addition to the first and the second apertures 120a and 120b. In some embodiments, the one or more second plurality of attachment mechanism 118a and 118b include a first plurality of holes 118a in the middle portion 110 of the main frame 100. The first plurality of holes 118a supports a first kind of fasteners. In some embodiments, the one or more second plurality of attachment mechanism 118a and 118b include a second plurality of holes 118b in the middle portion 110 of the main frame 100. The second plurality of holes 118b supports a second kind of fasteners. In some embodiments, the first plurality of holes 118a and the second plurality of holes 118b includes at least one of: one or more nuts and bolts, one or more screws, and one or more rivets.

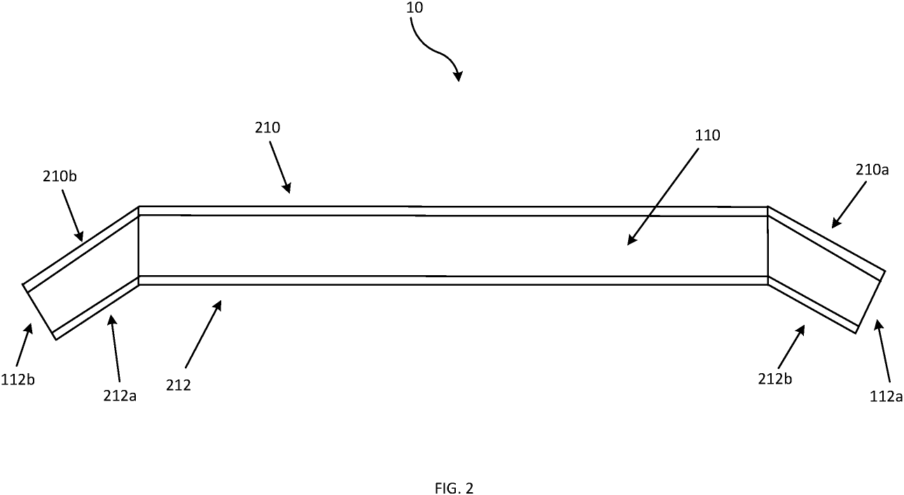

FIG. 2 illustrates a cross-view of an attachable pad 10 to attach a ladder, in accordance with some embodiments. In some embodiments, the attachable pad 10 includes a first cushion and a second cushion. The first cushion and the second cushion are used to add comfort to the user of the ladder. For example, when the user needs to brace the ladder for extended times, the user can brace towards the first cushion, or the second cushion, to become more comfortable and avoid the inevitable fatigue. This could improve safety of the user, avoid tiredness, and enables the worker to focus on his job. In some embodiments, a main portion 210 of the first cushion covers the first side of the middle portion 110. The main portion 210 covers at least partially the first side of the middle portion 110. In some embodiments, a first end portion 210a of the first cushion covers the first side of the first end portion 112a. The first end portion 210a covers at least partially the first side of the first end portion 112a. In some embodiments, a second end portion 210b of the first cushion covers the first side of the second end portion 112b. The second end portion 210b covers at least partially the first side of the second end portion 112b. The first cushion and the second cushion are used with a ladder to provide cushioning support, comfort, and protection to ladder users. In some embodiments, the first cushion and the second cushion include a rubber foam.

Alternatively, in some embodiments, a main portion 212 of the second cushion covers the second side of the middle portion 110. The main portion 212 covers at least partially the second side of the middle portion 110. In some embodiments, a first end portion 212a of the second cushion covers the second side of the first end portion 112a. The first end portion 212a covers at least partially the second side of the first end portion 112a. In some embodiments, a second end portion 212b of the second cushion covers the second side of the second end portion 112b. The second end portion 212b covers at least partially the second side of the second end portion 112b. In some embodiments, only one cushion is used.

To avoid undesired effect of exposing to water, while either using the ladder, storing the ladder in the storage, or shipping the ladder, the first cushion can include a water resistance material. Alternatively, in some embodiments, the second cushion can include a water resistance material. The first cushion and the second cushion may include different materials. Alternatively, the first cushion and the second cushion may include a same material. It should be noted that, in some embodiments, a single cushion may be used.

To avoid undesired effect of exposure to water, while either using the ladder, storing the ladder in the storage, or shipping the ladder, the first cushion can include a water resistance material. Alternatively, in some embodiments, the second cushion can include a water resistance material. The first cushion and the second cushion may include different materials. Alternatively, the first cushion and the second cushion may include a same material. It should be noted that, in some embodiments, a single cushion may be used.

FIG. 3, illustrates an exemplary aperture in accordance to some embodiments. In some embodiments the first aperture 120a, and similarly, the second aperture 120b includes a first flat portion 310a, a second portion 310b, a third portion 310c, a fourth portion 310d, and a fifth portion 310e. The first portion 310a is attached to a surface of the middle portion 110 via the attachment mechanism 114a and 114b. The second portion 310b is folded to a second folding degree 312a outward of the second side of the middle portion 110 and in a direction perpendicular to the second side of the middle portion 110. The third portion 310c is folded to a third folding degree 312b outward of the second side of the middle portion 110 and in the direction perpendicular to the second side of the middle portion 110. The fourth portion 310d is folded to a fourth folding degree 312c outward of the second side of the middle portion 110 and in the direction perpendicular to the second side of the middle portion 110. The fifth portion 310e is folded to a fifth folding degree 312d outward of the second side of the middle portion 110 and in the direction perpendicular to the second side of the middle portion 110. The first aperture 120a and the second aperture 120b are so designed to effectively attach the attachable pad 10 to the ladder. In a sense, the first aperture 120 and the second aperture 120b can be used as clamps to attach the attachable pad 10 to the ladder.

In some embodiments, the first flat portion 310a has a length of about 1 inch to about 5 inches, the second portion 310b has a length of about 0.75 inch to about 3 inches, the third portion 310c has a length of about 0.75 inch to about 2 inches, the fourth portion 310d has a length of about 1 inch to about 5 inches, and the fifth portion 310e has a length of about 1 inch to about 5 inches. The first portion 310a is attached to the middle portion 110 via the attachment mechanism 114a and 114b. In some embodiments, the second folding degree 312a is about 90 degrees to about 120 degrees outward of the second side of the middle portion 110 and in the direction perpendicular to the second side of the middle portion 110. In some embodiments, the third folding degree 312b is about 90 degrees to about 120 degrees outward of the second side of the middle portion 110 and in the direction perpendicular to the second side of the middle portion 110. In some embodiments, the fourth folding degree 312c is about 120 degrees to about 170 degrees outward of the second side of the middle portion 110 and in the direction perpendicular to the second side of the middle portion 110. In some embodiments, the fifth folding degree 312d is about 140 degrees to about 180 degrees outward of the second side of the middle portion 110 and in the direction perpendicular to the second side of the middle portion 110.

In some embodiments, the second folding degree 312a is about 112 degrees. In some embodiments, the third folding degree 312b is about 115 degrees. In some embodiments, the fourth folding degree 312c is about 150 degrees. In some embodiments, the fifth folding degree 312d is about 160 degrees.

In some embodiments, attachable pad 10 is attached to side rails of the ladder via the first aperture 120a and the second aperture 120b. In some embodiments, the attachable pad 10 is attached to one or more rungs of the ladder via the first aperture 120a and the second aperture 120b.

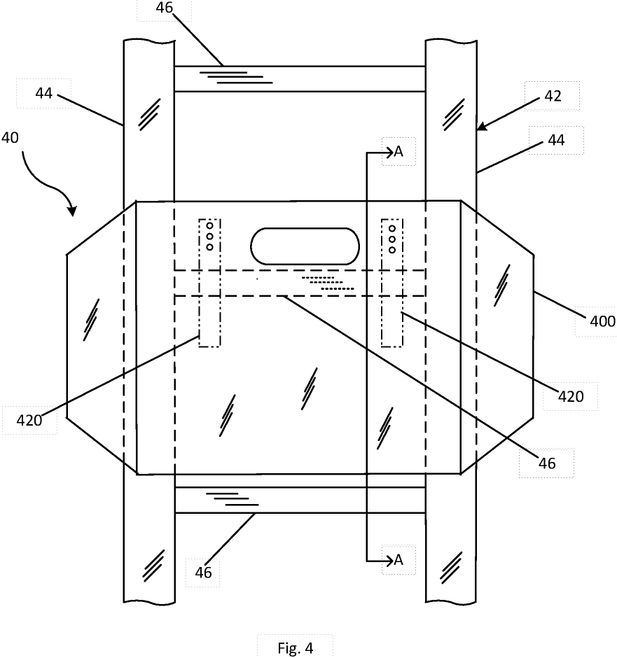

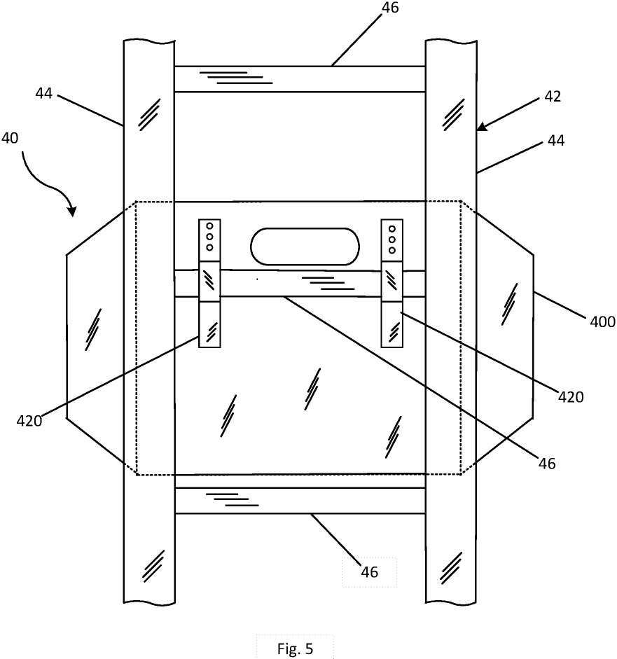

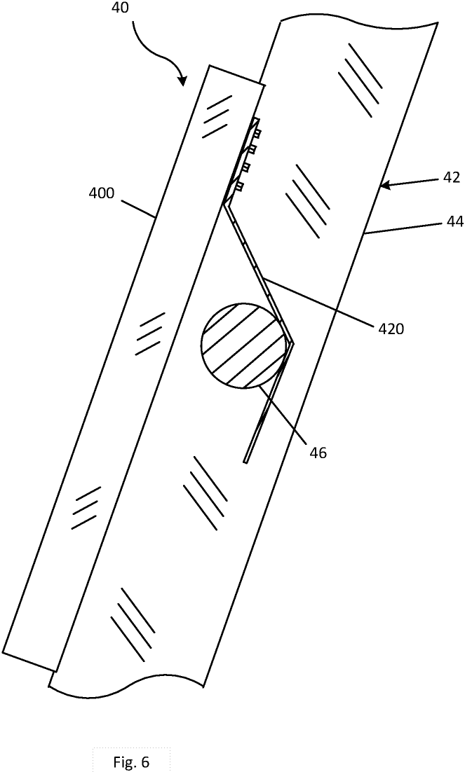

FIGS. 4-6 illustrates an embodiment of the attachable pad 40 of the present invention being attached to a ladder 42. The ladder 42 is a standard ladder having two legs 44 having a plurality of rungs 46 extending between the legs. The attachable pad 40 has generally a main frame 400 and two brackets 420. The main frame 400 can be a cushion and rests along the legs 44 of ladder 42. The brackets 420 are configured to engage and rest against a rung 46 of ladder 42. This allows pad 40 to be removably secured to the ladder 42. Once in place, a user can rest a leg, knee or other body parts against the pad 40 and not directly against the ladder 42. The component being describe as the bracket 420 with these embodiments is also the same component that was described with the term aperture with the above embodiments.

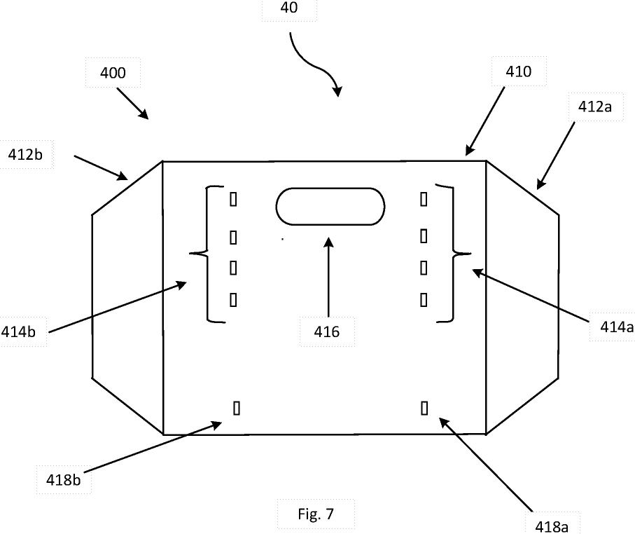

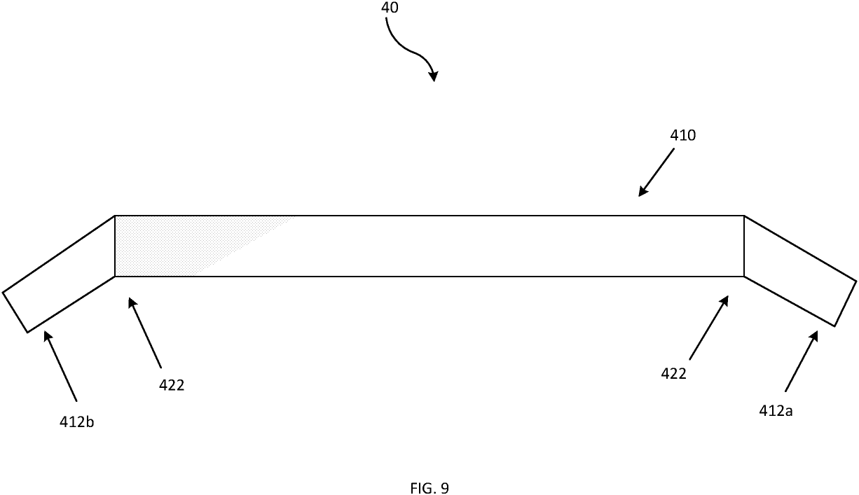

FIGS. 7-9 illustrate an additional embodiment of attachable pad of the present invention. In some embodiments, the attachable pad device 40 includes a main frame 400, a first bracket 420a, a second bracket 420b, and a first plurality of attachment mechanisms 414a and 414b.

The main frame 400 includes a middle portion 410, first end portion 412a, and a second end portion 412b. The middle portion 410 is substantially a flat surface. The first end portion 412a is attached to a first end of the middle portion 410. The first end portion 412a is folded to a first folding degree 422 towards a first side of the middle portion 410 and in a direction perpendicular to the first side. The second end portion 412b is attached to a second end of the middle portion 410. The second end portion 412b is folded to the first folding degree 422 towards the first side of the middle portion 410 and in a direction perpendicular to the first side. In some embodiments, the first folding degree is about 30 degrees to about 45 degrees, as shown in FIG. 7. In some embodiments, the middle portion 410 has a length of about 9 inches to about 19 inches, and a width of about 14 inches to about 24 inches. The first end portion 412a and the second end portion 412b have a length of about 9 inches to about 19 inches, and a width of about 1 inch to about 7 inches. In an embodiment, the middle portion 410 has a length of about 14 inches and a width of about 19 inches. The first end portion 412a and the second end portion 412b have a length of about 14 inches, and a width of about 4 inches.

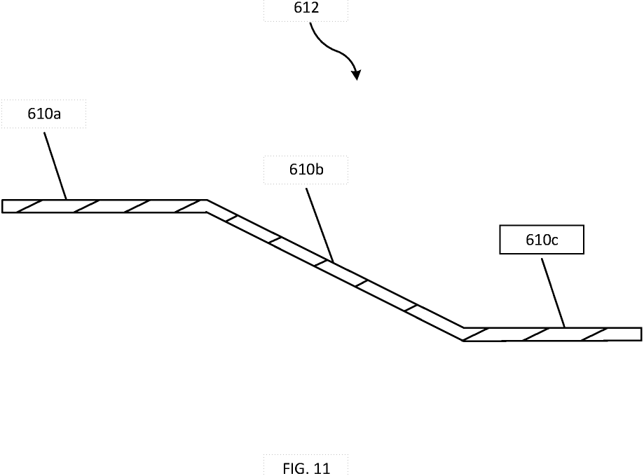

In some embodiments, the first bracket 420a is same as the second bracket 420b. For sake of simplicity, both the first bracket 420a and the second bracket 420b are shown by a single bracket 612 shown in FIG. 11. In some embodiments, the first bracket 420a is attached to an upper left portion of a second side of the middle portion 410. The second bracket 420b is attached to an upper right portion of the second side of the middle portion 410.

In some embodiments, one or more attachment mechanism 414a of the first plurality of mechanisms attaches the first bracket 420a to the first side of the middle portion 410. In some embodiments, one or more attachment mechanism 414b of the first plurality of attachment mechanisms attaches the second bracket 420b to the second side of the middle portion 410.

In some embodiments, the main frame 400 includes a hole 416. The hole 416 may be located in the middle portion 410. The hole 416 is used for handling the attachable pad 40. In some embodiments, the hole 416 is used as a handle to move the attachable pad 40. In some embodiments, the hole has a length of about 1 inch to about 7 inches, and a width of about 1 inch to about 4 inches. In a preferred embodiment, the hole has a length of about 4 inches to about 5 inches, and a width of about 2 inches to about 2.5 inches.

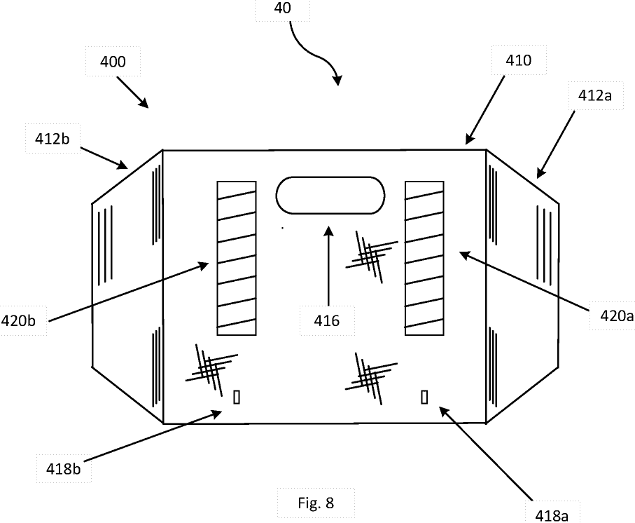

FIG. 8 illustrates a back-view of an attachable pad 40 to attach a ladder, in accordance with some embodiments. In some embodiments, the attachable pad 40 includes the first bracket 420a and the second bracket 420b. The first bracket 420a and the second bracket 420b are used to attach the attachable pad 40 to a ladder 42. The first bracket 420a and the second bracket 420b are so designed that they grip to a rung 46 the ladder 42 firmly, thus enable a user of the ladder 42 to lean towards the attachable pad 40 securely.

In some embodiments, the middle portion 410 of the main frame 400 includes one or more second plurality of attachment mechanisms 418a and 418b. The one or more second plurality of attachment mechanism 418a and 418b is used to attach the attachable pad 40 to the ladder 42, in addition to the first and the second bracket 420a and 420b. In some embodiments, the one or more second plurality of attachment mechanism 418a and 418b include a first plurality of holes 418a in the middle portion 410 of the main frame 400. The first plurality of holes 418a supports a first kind of fasteners. In some embodiments, the one or more second plurality of attachment mechanism 418a and 418b include a second plurality of holes 418b in the middle portion 410 of the main frame 400. The second plurality of holes 418b supports a second kind of fasteners. In some embodiments, the first plurality of holes 418a and the second plurality of holes 418b includes at least one of: one or more nuts and bolts, one or more screws, and one or more rivets.

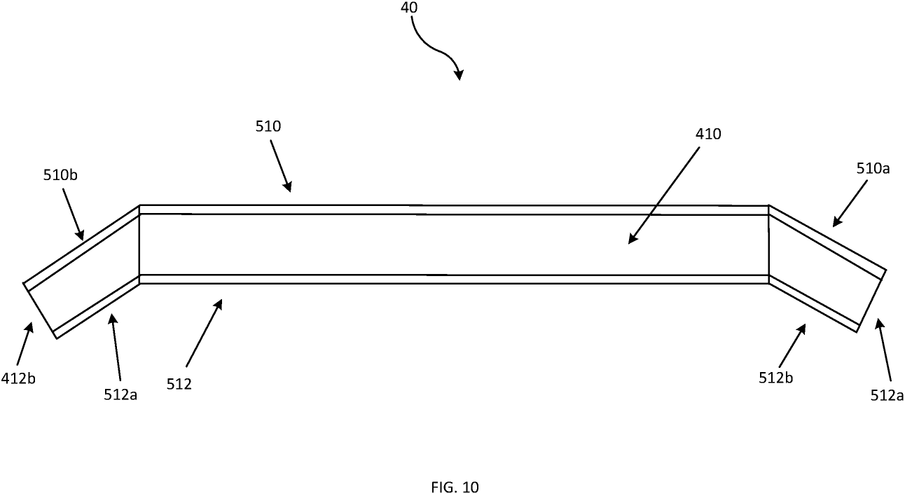

FIG. 10 illustrates a cross-view of an attachable pad 40 to attach a ladder 42, in accordance with some embodiments. In some embodiments, the attachable pad 40 includes a first cushion and a second cushion. The first cushion and the second cushion are used to add comfort to the user of the ladder. For example, when the user needs to brace the ladder for extended times, the user can brace towards the first cushion, or the second cushion, to become more comfortable and avoid the inevitable fatigue. This could improve safety of the user, avoid tiredness, and enables the worker to focus on his job. In some embodiments, a main portion 510 of the first cushion covers the first side of the middle portion 410. The main portion 510 covers at least partially the first side of the middle portion 410. In some embodiments, a first end portion 510a of the first cushion covers the first side of the first end portion 412a. The first end portion 510a covers at least partially the first side of the first end portion 412a. In some embodiments, a second end portion 510b of the first cushion covers the first side of the second end portion 412b. The second end portion 510b covers at least partially the first side of the second end portion 412b. The first cushion and the second cushion are used with a ladder to provide cushioning support, comfort, and protection to ladder users. In some embodiments, the first cushion and the second cushion include a rubber foam.

Alternatively, in some embodiments, a main portion 512 of the second cushion covers the second side of the middle portion 410. The main portion 512 covers at least partially the second side of the middle portion 410. In some embodiments, a first end portion 512a of the second cushion covers the second side of the first end portion 412a. The first end portion 512a covers at least partially the second side of the first end portion 412a. In some embodiments, a second end portion 512b of the second cushion covers the second side of the second end portion 412b. The second end portion 512b covers at least partially the second side of the second end portion 412b. In some embodiments, only one cushion is used.

To avoid undesired effect of exposing to water, while either using the ladder, storing the ladder in the storage, or shipping the ladder, the first cushion can include a water resistance material. Alternatively, in some embodiments, the second cushion can include a water resistance material. The first cushion and the second cushion may include different materials. Alternatively, the first cushion and the second cushion may include a same material. It should be noted that, in some embodiments, a single cushion may be used.

FIG. 11 illustrates an exemplary bracket 612 in accordance with some embodiments. In some embodiments the first bracket 420a, and similarly, the second bracket 420b includes a flat first portion 610a, an angled second portion 610b and a flat third portion 610c. The flat first portion 610a is attached to a surface of the middle portion 410 via the attachment mechanism 414a and 414b. The second portion 610b is directed in an angled direction away from the flat first portion 610a. The flat third portion 610c is substantially parallel with flat first portion 610a. The first bracket 420a and the second bracket 420b are so designed to effectively attach the attachable pad 40 to the ladder.

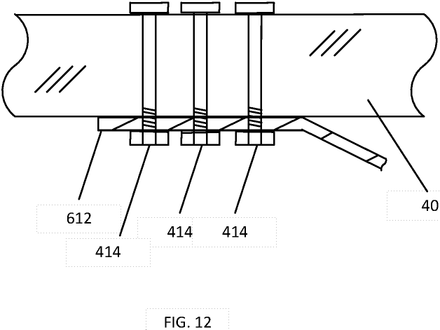

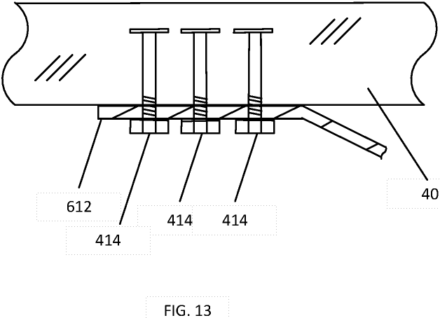

FIGS. 12 and 13 show embodiments of bracket 612 being secured to attachable pad 40 with a plurality of attachment mechanisms 414. In FIG. 12, the attachment mechanisms 414 are shown extending completely through attachable pad 40. In FIG. 13, the attachment mechanism 414 are shown to be embedded within attachable pad 40. Attachment mechanism 414 can be any type of fastener, such as a screw or bolt.

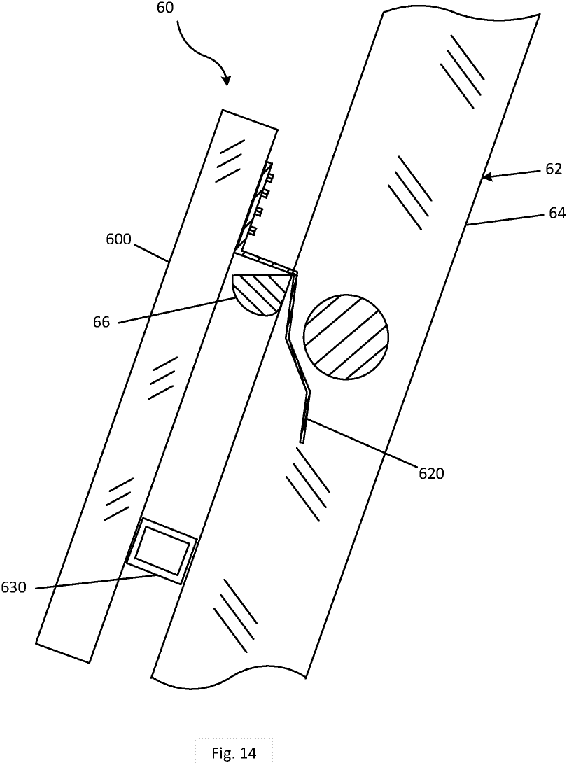

FIG. 14 illustrates an embodiment of the attachable pad 60 of the present invention being attached to a ladder 62. The ladder 42 is a standard multi-task ladder having a leg 64 having a plurality of rungs 66 extending between the legs. The attachable pad 60 has generally a main frame 600 and two brackets 620. The main frame 400 can be a cushion and and a support 630 which rests along the leg 64 of ladder 62. The brackets 620 are configured to engage and rest against a rung 66 of ladder 62. This allows pad 60 to be removably secured to the ladder 62. Once in place, a user can rest a leg, knee or other body parts against the pad 60 and not directly against the ladder 62. The component being describe as the bracket 620 with these embodiments is also the same component that was described with the term aperture with the above embodiments.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. An attachable pad to attach to a ladder, the attachable pad comprising:
a main frame including
a middle portion, the middle portion being substantially a flat surface,
a first end portion attached to a first end of the middle portion, the first end portion folded to a first folding degree towards a first side of the middle portion,
a second end attached to a second end of the middle portion, the second end portion folded to the first folding degree towards the first side of the middle portion,
a first bracket attached to an upper left portion of a second side of the middle portion,
a second bracket attached to an upper right portion of the second side of the middle portion, the second aperture being substantially same as the first aperture, and
a mechanism to attach the first bracket and the second bracket to the second side of the middle portion.

2. The device of claim 1, further comprising:
a first cushion on the first side of the main frame and covering at least partially the first side of the main frame.

3. The device of claim 2, wherein the first cushion includes water resistance materials.

4. The device of claim 1, further comprising:
a second cushion on the second side of the main frame and covering at least partially the second side of the main frame.

5. The device of claim 4, wherein the second cushion includes a water resistance material.

6. The device of claim 1, further comprising:
a hole in the middle portion for handling the attachable pad.

7. The device of claim 1, further comprising:
a first plurality of holes in the middle portion to support a first kind of fasteners; and
a second plurality of holes in the middle portion support a second kind of fasteners.

8. The device of claim 1, wherein the attachable pad is attached to side rails of the ladder via the first aperture and the second aperture.

9. The device of claim 1, wherein the attachable pad is attached to one or more rungs of the ladder via the first bracket and the second bracket.

10. The device of claim 1, wherein the first folding degree is about 30 degrees to about 45 degrees.

11. The device of claim 1, wherein the attachment mechanism comprises at least one of: one or more nuts and bolts, one or more screws, and one or more rivets.
